(19) United States
(12) Patent Application Publication
(10) Pub. No.: US 2014/0049730 A1
(43) Pub. Date: Feb. 20, 2014

(54) LED DRIVER WITH BOOST CONVERTER CURRENT CONTROL

(71) Applicant: Bing Lu, Manchester, NH (US)

(72) Inventor: Bing Lu, Manchester, NH (US)

(73) Assignee: Texas Instruments Incorporated, Dallas, TX (US)

(21) Appl. No.: 13/586,607

(22) Filed: Aug. 15, 2012

(51) Int. Cl. H05B 37/02; H02J 1/00; G02F 1/13357

(52) U.S. Cl. 349/69; 315/185 R; 315/193; 307/31

(57) ABSTRACT

An electronic circuit includes a driver for an LED light, having an isolated DC-DC converter having a first output at a higher voltage referred to a floating ground and a second output at a lower voltage than said first output and referred to a reference voltage. A DC-DC boost converter receives its input power from the second output of the isolated DC-DC converter and having its output coupled to the floating ground, whereby an output voltage to a LED light receives the sum of the voltages of the first output of the isolated DC-DC converter and the output of the DC-DC boost converter.

### FIELD OF THE INVENTION

The invention relates to an LED driver, and more specifically, to a driver for a string of LEDs

### BACKGROUND OF THE INVENTION

LED lighting is becoming very popular to replace incandescent lighting and fluorescent or compact fluorescent (CFL) lighting for area lighting, and more specifically, for the backlighting for LCD televisions, also known as LED televisions. In order to achieve the desired brightness and to maintain the spectrum characteristics of the LED, the current through the LED is controlled to be constant. Therefore, multiple LEDs are normally connected in a series string in order to maintain a constant current through all of the LEDs. The LEDs brightness can then be adjusted through pulse width modulation in order to dim the light output of the LEDs while maintaining the correct color spectrum. As is well known, the forward voltage drop of an LED varies from device to device, with age and with temperature. Therefore, it is not possible to merely supply a constant voltage across the string in order to maintain the current through the string constant.

FIG. 1 shows a well-known technique for controlling the current through LED string 106 generally as 100. The LED string 106 is driven by a DC-DC converter which is controlled by a control loop 104. Control loop 104 is responsive to a voltage generated across series resistor 108 in order to maintain the current through the LED string 106 constant. This is a simple and workable solution provided that the DC-DC converter 102 is only supplying power to the LED string 106 and dimming is not necessary.

FIG. 2 shows another well-known prior art technique for controlling the current through LED string 206, generally as 200. In this implementation, the DC-DC converter 202 is operated in a constant voltage and provides power for driving current through the series of LEDs. A NMOS transistor 210 is coupled in series with the LED string 206 and controlled by a constant current control 204. A resistor 208 in series with the LED string 206 and the NMOS transistor 210 provide a voltage corresponding to the current through the string. The constant current control 204 then controls the transistor 210 to control the current through the LED string 206. The transistor absorbs the excess voltage. This method is less efficient than the circuit shown in FIG. 1, because of the power dissipated in transistor 210. In view of the fact that the DC-DC converter 202 always operates at the same voltage, current control takes place by dissipating the excess voltage, thus wasting power.

A third prior art technique, particularly applicable to television sets or other devices requiring additional supply voltages, is shown in FIG. 3, generally as 300. In this technique, the DC-DC converter 308 provides multiple outputs, here shown as 5 V and 12 V, in addition to the LED output. The 5 VDC supply can be used to operate receiver circuits and microprocessor circuits within the television set; for example, the 12 VDC supply can be used to power the audio amplifiers. In the example shown in FIG. 3, a power factor correction circuit 302 is coupled to the AC mains 304 for receiving an input voltage, typically 115 VAC or 230 VAC. The power factor correction circuit corrects the input current so that the television receiver looks as a primarily resistive load. For example, the output voltage 306 may be 400 VDC. The voltage output 306 from the power factor controller 302 is input to a LLC DC-DC converter 308. In addition to the 5 VDC and 12 VDC supplies, the DC-DC converter 308 produces a voltage 311 which is used to operate the LEDs in string 334. In order to adjust the current through the LED string 334, the voltage VLED is boosted by boost DC-DC converter 322. Boost converter 322 includes an input capacitor 324 and output capacitor 330, both of which are connected to ground. In series between the voltage VLED and the LED string 334 is a diode 328 and inductor 326. The node between the diode 328 and inductor 326 is connected to a NMOS switching transistor 332, the channel of which is connected to ground. The NMOS transistor 332 is connected to an LED boost controller 340 which operates the opening and closing of the NMOS switch 332 to boost the output voltage and maintain the current through the LED string 334 constant. The current through the LED string 334 is measured by the voltage generated across series resistor 338, which is connected to the LED boost controller at 344. Also shown is an optional dimming feature by operating series NMOS transistor 336 via control signal produced by LED boost controller 340 on line 342 in response to a dimming signal 346.

A disadvantage of this circuit is that the boost converter processes the entire power required by the LED string, which reduces the efficiency because the entire power has been processed. In addition, because the boost converter is handling the full voltage and current of the LED output, the cost of the circuitry is increased because high-voltage components are required. This also results in a larger inductor size due to the high output voltage. The switching losses are higher because higher voltage components and results in a limitation on the maximum switching frequency, which in turn increases the inductor size and cost.

Accordingly, an improved LED driver having higher efficiency and reduce costs is desired.

### SUMMARY OF THE INVENTION

It is a general object of the invention to provide an electronic circuit comprising an LED driver for string of LEDs utilizing a boost converter for current control.

An aspect of the invention includes a driver for an LED light comprising an isolated DC-DC converter having a first output at a higher voltage referred to a floating ground and a second output at a lower voltage than said first output, and referred to a reference voltage. A DC-DC boost converter receives input power from the second output of the isolated DC-DC converter and has an output coupled to the floating ground, whereby an output voltage to a LED light receives the sum of the voltages of the first output of the isolated DC-DC converter and the output of the DC-DC boost converter.

A further aspect of the invention includes a method of driving an LED comprising coupling a first output voltage of an isolated DC-DC converter to an output of a DC-DC boost converter, operating the DC-DC boost converter from a second output voltage, the second output voltage being lower than the first output voltage of the isolated DC-DC converter, providing an output equal to a sum of the first output voltage, and the output of the DC-DC boost converter coupled to the LED for driving the LED.

A third aspect of the present invention includes an LCD television having an LED backlight comprising a power factor control circuit coupled to the AC mains power factor correcting an input current, an isolated DC-DC converter having multiple output voltages, a first higher voltage referred to a floating ground in a second low-voltage referred to ground, a DC-DC boost converter receiving input power from the second voltage output and having an output coupled to the floating ground, a series string of LEDs forming a backlight for an LCD television display being coupled to the higher voltage output for receiving a sum of the higher voltage and voltage at the output of the DC-DC boost converter, and a resistance is in series with the string of LEDs for measuring current there through coupled to the boost converter for maintaining current through the string of LEDs constant.

### BRIEF DESCRIPTION OF DRAWINGS

Further aspects of the invention will appear from the appending claims and from the following detailed description given with reference to the appending drawings.

FIG. 1 is a schematic of a prior art technique for controlling the current through an LED string;

FIG. 2 is a schematic of a second prior art technique for controlling the current through an LED string;

FIG. 3 is a schematic of a third prior art technique for controlling the current through an LED string;

FIG. 4 is a block diagram of a first embodiment of the present invention; and

FIG. 5 is a schematic block diagram of a second embodiment of the present invention.

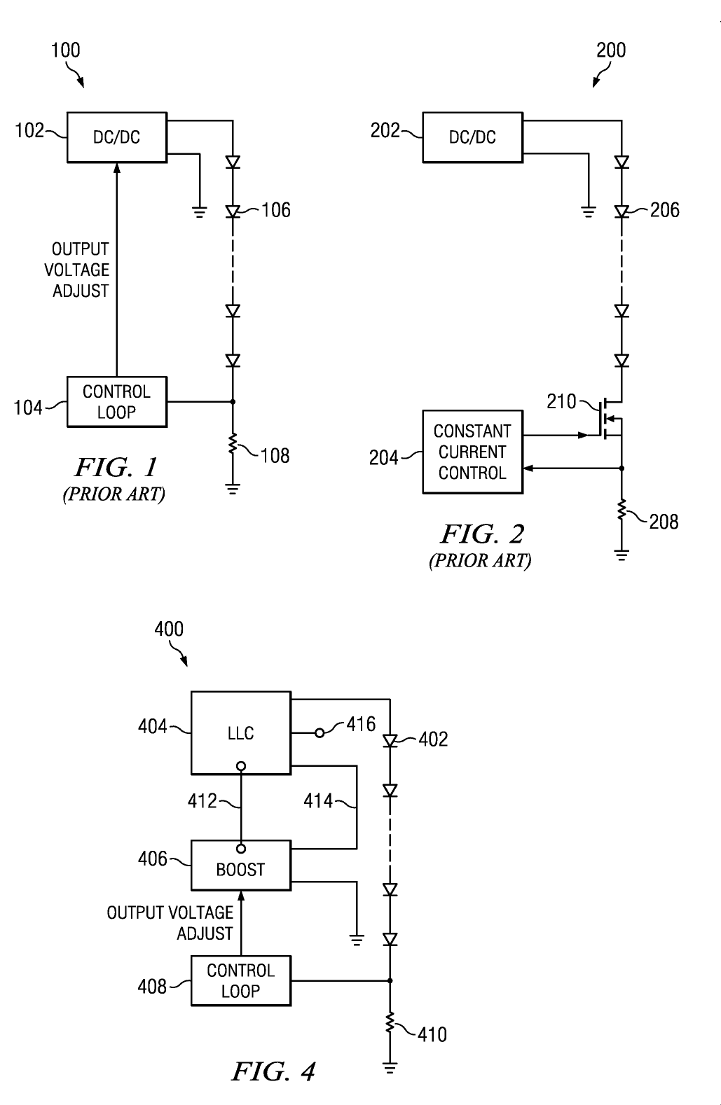

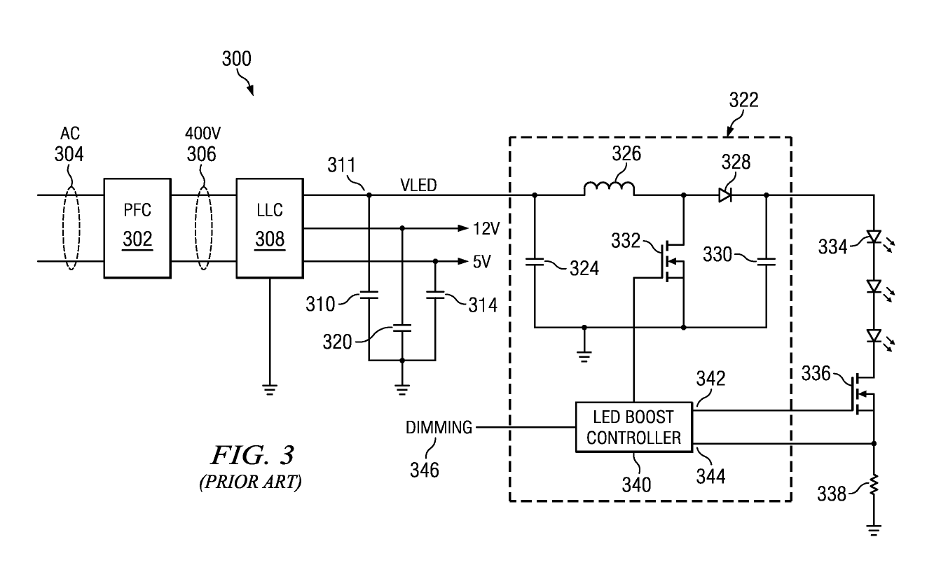

### DETAILED DESCRIPTION OF EXAMPLE EMBODIMENTS

FIG. 4 shows a simplified block diagram of a first embodiment of the present invention, generally as 400. In FIG. 4, the LLC DC-DC converter 404 provides an output to operate the series string of LEDs 402. A resistor 410 is in series with the LEDs 402 and provides a voltage proportional to the current through the LEDs. A boost DC-DC converter 406 is coupled to receive an input voltage 412 which is one of the plurality of outputs 412, 416 from the DC-DC converter 404, and which are at a much lower voltage than that provided to the LED string 402. The optional auxiliary output 416 can be used to drive other circuitry, such as an audio amplifier, for example. The boost converter 406 provides an output at 414 which adds to the output voltage of the DC-DC converter 404 to provide the voltage for LED string 402. This additional voltage is used to control the current through the LED string 402. The voltage received by the boost converter 406 through input 412 is referred to ground. A voltage generated across resistance 410 is indicative of the current flow through LED string 402 and is input to control loop 408. Control loop 408 generates a control signal which operates the boost DC-DC converter 406 to control the output voltage, which in turn controls the current through LED string 402. In this manner, the current through string 402 remains constant. It should be noted that the DC-DC converter need not be a LLC converter, but other isolated DC-DC converters may be utilized. Non-limited examples of other converters that may be utilized are half-bridge converters, full-bridge converters and flyback converters.

In this embodiment, the LED current is controlled by the boost converter. The boost converter only provides a small portion of the LED power, so the overall system efficiency may be improved, because the majority of the LED power is not processed by the boost converter and is directly transferred to the load. In view of the fact that the boost converter handles less voltage and less power, the frequency of the boost converter may be increased which reduces the cost and improves its efficiency.

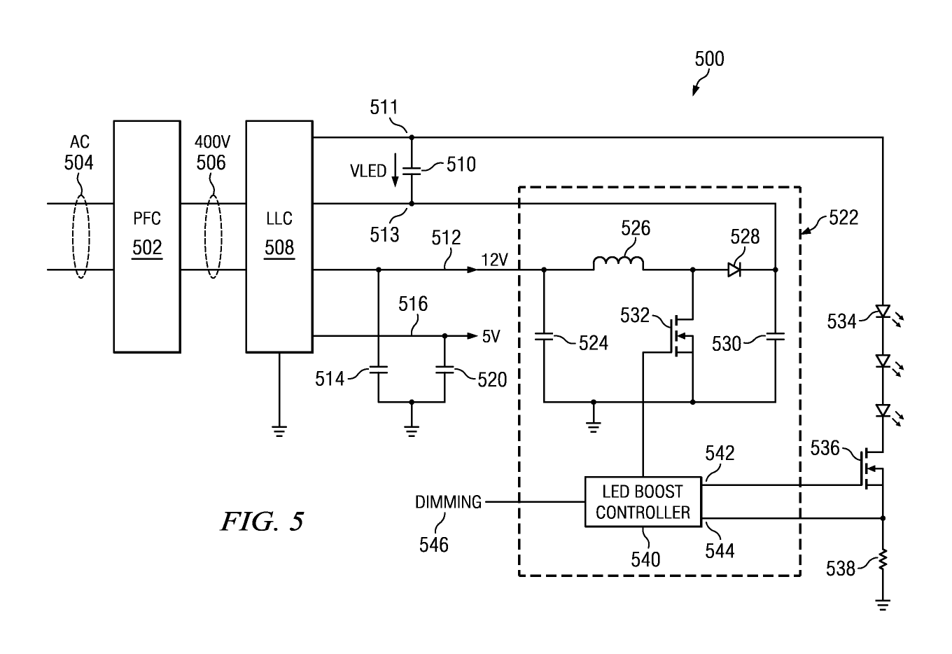

FIG. 5 shows an embodiment of the present invention suitable for producing the power for a television receiver or other equipment utilizing multiple output voltages from the DC-DC converter, generally as 500. The circuit shown in FIG. 5 has a power factor controller 502 connected to the AC mains at 504 for receiving an input voltage, which is typically 115 or 230 VAC. The power factor controller adjusts the input current on the AC mains so that the circuit appears to be mostly resistive. The power factor controller may be any well-known power factor control circuit. It is an optional feature and not required to practice the present invention, but is commonly found in devices such as television sets or other devices utilizing LED lights.

The output of the power factor correction circuit 506 may be typically 400 VDC, which is applied to the input of the DC-DC converter 508. Input voltage 506 is dependent upon the voltage at the AC mains and is not a component of the present invention. The DC-DC converter 508 is shown in FIG. 5 as a LLC converter. It generates three output voltages. The first voltage 512 is at 12 VDC and appears across capacitor 514, the opposite terminal of which is connected to ground. The second voltage at 5 VDC appears across capacitor 520, the other terminal of which is connected to ground. The third output at 511 is the voltage VLED which is used to drive the LED string 534. This voltage appears across capacitor 510, which has a terminal 513 which floats with respect to ground. The voltage on terminal 511 is connected to the LED string 534. The boost converter 522 operates from the 12 VDC supply 512 rather than from the voltage VLED. Thus, the boost converter may utilize lower voltage components, operate at a much higher switching frequency which reduces the size of the external components and operates at a higher efficiency.

The boost converter 522 comprises inductor 526 which is in series between the 12 VDC supply and the anode of diode 528. A capacitor 524 is connected between the 12 VDC supply and ground and a capacitor 530 is connected to the cathode of diode 528 and connected to ground. An NMOS switching transistor 532 has its channel connected between the node between inductor 526 and diode 528 and ground. The gate of NMOS transistor 532 is connected to LED boost controller 540. The output of the boost converter 522 is connected to the floating ground for voltage VLED terminal 513. Therefore, the output of the boost converter 522 adds to the voltage VLED and the sum of these two voltages is applied at terminal 511 to the LED string 534. The LED string 534 is of a plurality of diodes connected in series. A resistor 538 is in series with the LEDs and the voltage across resistor 538 is applied to the LED boost controller at 544. The LED boost controller utilizes this voltage to switch the MOS transistor 532 and thus control the magnitude of the output voltage from boost converter 522. In addition, FIG. 5 shows an optional dimming feature in which NMOS transistor 536 is in series with the diode string 534 between the diode string 534 and the resistor 538. This transistor is operated by the LED boost controller 540 in response to the dimming signal 546 to turn the transistor 536 on and off, utilizing pulse width modulation in order to dim the light output of the LED string 534 without affecting the color spectrum produced by the LEDs.

The boost converter 522 illustrated in FIG. 5 is only an example of one type of boost converter that can be utilized. Other well-known isolated DC-DC boost converter circuits may be utilized. In the boost converter 522, when the NMOS transistor 532 is on, current flows through inductor 526 and when the NMOS transistor 532 is off, inductor current will flow through diode 528 and to capacitor 530. As is well known to those skilled in the art, the output voltage VO is equal to the input voltage divided by 1 minus the duty cycle of the switch. Thus, by controlling the duty cycle of the transistor switch 532, the output voltage from boost converter 522 and thus the voltage applied to the LED string 534 may be controlled, so that the current through LED string 534 is constant, regardless of manufacturing tolerances, the age of the devices and the temperature at which they operate.

The LED boost controller 540 is shown as being part of the boost converter 522; it can be a separate integrated circuit device and the other components may be discrete devices, not within the same module as indicated in FIG. 5. The DC-DC converter 508 may be any isolated type of DC-DC converter, including; for example, a half-bridge converter, a full-bridge converter, a flyback converter, or (as illustrated) a LLC converter. It should be noted that although three output voltages are shown from DC-DC converter 508, the third voltage output need not be present to practice the present invention. In addition, it is possible that more than three voltages are generated by the DC-DC converter 508 for other unrelated purposes without departing from the present invention.

In this embodiment, the LED current is controlled by the boost converter. The boost converter only provides a small portion of the LED power, so the overall system efficiency may be improved, because the majority of the LED power is not processed by the boost converter and is directly transferred to the load. In view of the fact that the boost converter handles less voltage and less power, the frequency of the boost converter may be increased which reduces the cost and improves its efficiency.

Although the invention has been described in detail, it should be understood that various changes, substitutions and alterations may be made thereto without departing from the spirit and scope of the invention as defined by the appended claims.

1. A driver for an LED light comprising:
an isolated DC-DC converter having a first output at a higher voltage referred to a floating ground and a second output at a lower voltage than the first output and referred to a reference voltage;
a DC-DC boost converter receiving input power from the second output of the isolated DC-DC converter and having its output coupled to the floating ground, whereby an output voltage to a LED light receives the sum of the voltages of the first output of the isolated DC-DC converter and the output of the DC-DC boost converter.

2. The driver of claim 1, wherein the DC-DC boost converter is a variable output voltage to maintain current through the LED light constant.

3. The driver of claim 2, wherein the first output at a higher voltage of the isolated DC-DC converter is operated at a fixed output voltage.

4. The driver of claim 1, wherein the driver is coupled to a series string of LEDs.

5. The driver of claim 4, further comprising a resistance coupled in series with the string of LEDs to provide a current feedback signal to the boost DC-DC converter.

6. The driver of claim 1, wherein the isolated DC-DC converter is selected from the group consisting of a LLC converter, a half-bridge converter, a full-bridge converter and a flyback converter.

7. The driver of claim 4, as to wherein the LED string is a backlight for a LCD display.

8. The driver of claim 4, wherein the LED string is a backlight for an LCD display television set, the second output voltage powering television circuitry.

9. The driver of claim 1, wherein the isolated DC-DC converter provides a third output voltage for powering other circuits.

10. The driver of claim 1, wherein the isolated DC-DC converter is preceded by a power factor controller (PFC).

11. The driver of claim 4, further comprising a switch in series with the LED string for dimming the LEDs.

12. A method of driving an LED comprising:
coupling a first output voltage of an isolated DC-DC converter to an output of a DC-DC boost converter;
operating the DC-DC boost converter from a second output voltage, the second output voltage being a lower than the first output voltage, of the isolated DC-DC converter; and
providing an output equal to a sum of the first output voltage and the output of the DC-DC boost converter coupled to the LED for driving the LED.

13. The method of claim 12, further comprising:
operating the DC-DC boost converter to have a variable output voltage to maintain current through the LED constant.

14. The method of claim 13, wherein the isolated DC-DC converter is operated at a fixed voltage.

15. The method of claim 12, wherein the LED comprises a series of string LEDs.

16. The method of claim 12, further comprising providing a current measurement signal to the DC-DC boost converter to maintain a constant current through the LED.

17. The method of claim 12, wherein the isolated DC-DC converter is selected from the group consisting of an LLC converter, a half-bridge converter, a full-bridge converter and a flyback converter.

18. The method of claim 12, further comprising a power factor controlling an input voltage to the isolated DC-DC converter.

19. The method of claim 15, further comprising switching current through the LED string for dimming the LEDs.

20. An LCD television having an LED backlight comprising:
a power factor control circuit coupled to the AC mains power factor correcting an input current;
an isolated DC-DC converter having multiple output voltages, a first higher voltage referred to a floating ground in a second low-voltage referred to ground;
a DC-DC boost converter receiving input power from the second voltage output and having an output coupled to the floating ground;
a series string of LEDs forming a backlight for an LCD television display being coupled to the higher voltage output for receiving a some of the higher voltage and voltage at the output of the DC-DC boost converter; and
a resistance in series with the string of LEDs for measuring current there through coupled to the boost converter for maintaining current through the string of LEDs constant.
